(19) United States
(12) Patent Application Publication
(10) Pub. No.: US 2019/0376928 A1
(43) Pub. Date: Dec. 12, 2019

(54) Electrochemical Stripping Analysis Using Vertically Free Standing Graphene containing Carbon Nanosheets as Electrode Materials

(71) Applicants: Wei Zheng, Williamsburg, VA (US); Xin Zhao, North Potomac, MD (US)

(72) Inventors: Wei Zheng, Williamsburg, VA (US); Xin Zhao, North Potomac, MD (US)

(21) Appl. No.: 16/005,150

(22) Filed: Jun. 11, 2018

(51) Int. Cl. G01N 27/42

(52) U.S. Cl. CPC G01N 27/42

(57) ABSTRACT

This disclosure is about invention of electrodes for electrochemical stripping analysis comprising vertically free standing graphene containing Carbon Nanosheets, which is a novel material being distinctly different from graphite, planer graphene, carbon nanotubes, carbon nanowalls, carbon nanoflakes, graphene nanoplatelets, aggregated graphene powders made of exfoliated graphite flakes etc. Performance enhancement effects of electrodes are achieved by unique structure, morphology, topography and crystal defects of vertically free standing graphene containing Carbon Nanosheets: large surface area, exceptional electrical conductivity, good mechanical strength and edge effects. An enhanced electrical conductivity and surface area of electrodes can yield high signal level in electrochemical stripping analysis. More over, vertically free standing graphene containing Carbon Nanosheets can carrier more target substance-to-be-analyzed, catalyst particles, or additives due to the large surface area, high density of graphene edges and large number of actived atomistic sites of vertically free standing graphene containing Carbon Nanosheets.

### BACKGROUND OF THE INVENTION

The technology disclosed herein relates generally to electrochemistry. More particularly, the technology disclosed herein relates to using vertically free standing graphene containing Carbon Nanosheets as electrodes or component of electrodes for electrochemical stripping analysis.

Electrochemical stripping analysis is a set of analytical chemistry methods based on voltammetry or potentiometry that are used for quantitative determination of ions in solution. Stripping voltammetry being usually classified as anodic, cathodic and adsorptive stripping voltammetry, is a major approach of electrochemical stripping analysis. Electrochemical stripping analysis have been employed for analysis of organic molecules as well as metal ions.

Electrodes for electrochemical stripping analysis are devices where voltage is applied, electric charges move, signal is sensed and chemical or physical changes happen. Electrodes are key devices for electrochemical applications. Normally, three electrodes are used in electrochemical stripping analysis. They are working electrode, counter electrode and reference electrode. In some cases, only working electrode and counter electrode are used.

Traditionally, carbon materials, like carbon paste, glassy carbon paste, and glassy carbon electrodes when modified are termed as chemically modified electrodes and have been employed for the analysis of organic and inorganic compounds. Noble metals like gold and platinum are also used as electrodes material. Especially, platinum is widely used as a material for counter electrode. Recently, it has been reported nano materials also being employed as electrode materials, e.g. carbon nano tubes, nano arrays, and graphene. Further more, there is a trend that electrodes are integrated into a chip.

Electrochemical stripping analysis has two major steps: 1) preconcentration of substance-to-be-analyzed onto a solid electrode surface or into additives, e.g. mercury (liquid) and bismuth which attached to electrode surface; 2) stripping the substance-to-be-analyzed off from the electrode during a potential sweep.

Electrochemical stripping analysis has the following properties: 1) sensitive and reproducible (RSD<5%) method for trace metal ion analysis in aqueous media; 2) concentration limits of detection for many metals are in the low ppb to high ppt range; 3) field deployable or mobile instrumentation that is inexpensive; 4) approximately 12-15 metal ions can be analyzed for by this method; 5)The stripping peak currents (signal) and peak widths are a function of the size, coverage and distribution of the substance-to-be-analyzed on the electrode surface.

A simplified diagram of electrochemical stripping analysis system with electrodes is shown in FIG. 1, whose components consists of, but not limited to, a working electrode 110, a counter electrode 120, an electrolyte 130 (usually in liquid form), and a reference electrode 140. In some application, there is a membrane between electrodes.

In an electrochemical stripping analysis system, electrodes are often classified as or called working electrodes, counter electrodes, reference electrodes. In some cases, electrodes can also classified as or called anode, cathode.

As a thin film material, a vertically free standing graphene containing Carbon Nanosheet (a.k.a “Carbon Nanosheets”) is a novel carbon nanomaterial with a range of graphene and graphitic crystal structure invented by Dr. J. J. Wang et al. at the College of William and Mary. Dr. W. Zheng et al. further invented a novel method to grow this material safer, faster, and affordable for mass production [Need Citation]. As used herein, a “Carbon Nanosheet” refers to a carbon nanomaterial with a thickness of three nanometers or less. A Carbon Nanosheet is a two-dimensional graphitic sheet made up of a single to ten atomic layers of graphene. Carbon Nanosheet is a Few-Layer Graphene material based on international graphene vocabulary standard [Need Citation]. Edges of a Carbon Nanosheet usually terminate by a single layer of graphene. The specific surface area of a Carbon Nanosheet is between 1000 m²/g to 2600 m²/g. The height of a Carbon Nanosheet varies from 100 nm to 8 μm, depending on fabrication conditions. The width of a Carbon Nanosheet also varies from hundreds of nanometers to a few microns. A plurality of Carbon Nanosheets, each of which comprises at least one layer of graphene, are disposed orthogonally to a coated surface of a substrate. Essentially, the plurality of vertically free standing Carbon Nanosheets are functioning as space-organizers at nanoscale. By partitioning the space above the surface of the substrate, these vertically free standing Carbon Nanosheets can greatly enlarge the surface area of the substrate.

Hereby the term “free-standing” or the term “vertically free standing” refers to in-situ self-organized growth of carbon nanostructures to a surface semi-orthogonally, or at various angles from 0 to 180 degree with respect to the surface. Furthermore, nanostructures of Carbon Nanosheet stretch out not only in a straight way, but also can have a crumpling, tilting, folding, sloping, or “origami”-like structure. A variety of structural defects, such as 5 or 7 member sp2-bond C rings, make the nanostructure standing up freely towards open space. Literally, Carbon Nanosheet is comprised of a few layers of defected graphene. It is the inherent crystal structure defects, which makes the carbon nanomaterial different that an ideal model of Graphene. The unique structure and morphology of Carbon Nanossheets results from two-dimensional preferential crystal growth of the carbon material in a special plasma process condition.

By virtue of their graphene and graphitic structure, Carbon Nanosheets have very high electrical conductivity. Graphene is known as one of the strongest materials, and it has a breaking strength over 100 times greater than that of a hypothetical steel film of the same thickness. Morphology of Carbon Nanosheets can remain stable at temperatures up to 1000° C. A Carbon Nanosheet has a large specific surface area because of its sub-nanometer thickness. Referring to FIG. 2, it shows the structure of Carbon Nanosheet 220 standing up freely on a substrate 210. With only 1 to 7 layers of graphene, the Carbon Nanosheet is less than 2 nm thick. Its height and length is about 1 micrometer respectively. The structure and fabrication method of Carbon Nanosheets have been published in several peer-reviewed journals such as: Wang, J. J. et al., “Free-standing Subnanometer Graphite Sheets”, Applied Physics Letters 85, 1265-1267 (2004); Wang, J. et al., “Synthesis of Carbon Nanosheets by Inductively Coupled Radio-frequency Plasma Enhanced Chemical Vapor Deposition”, Carbon 42, 2867-72 (2004); Wang, J. et al., “Synthesis and Field-emission Testing of Carbon Nanoflake Edge Emitters”, Journal of Vacuum Science & Technology B 22, 1269-72 (2004); French, B. L., Wang, J. J., Zhu, M. Y. & Holloway, B. C., “Structural Characterization of Carbon Nanosheets via X-ray Scattering”, Journal of Applied Physics 97, 114317-1-8 (2005); Zhu, M. Y. et al., “A mechanism for Carbon Nanosheet formation”, Carbon, 2007.06.017; Zhao, X. et al., “Thermal Desorption of Hydrogen from Carbon Nanosheets”, Journal of Chemical Physics 124, 194704 (2006), as well as described by Zhao, X. in U.S. Patent “Supercapacitor using Carbon Nanosheets as electrode” (U.S. Pat. No. 7,852,612 82); and Wang, J. et al., in U.S. Patent “Carbon nanostructures and methods of making and using the same” (U.S. Pat. No. 8,153,240 82), which are incorporated herein by reference in their entirety.

As described above, the vertically free standing graphene containing Carbon Nanosheet is a novel material which is distinctly different from the ideal model Graphene material with one or two atomic layers laying on a plane substrate, Graphite, Carbon Nanotubes, Carbon Nanowalls, Petal Like Graphitic Sheets, Carbon Nanoflakes, Graphene Nanoplatelets, Aggregated Graphene from exfoliated graphite, etc. The vertically free standing graphene containing Carbon Nanosheet is also called Fluffy Graphene or CNS as a trade name by the inventors. Noticeably, Petal like Graphitic Sheets, Carbon Nanowalls and Carbon Nanoflakes had a similar free standing morphology, and these carbon nanomaterials were invented by contemporary materials scientists in early years of 2000's. However, those carbon nanomaterials could not be treated as a graphene material, because its graphitic thickness is more than ten nanometers, or thicker than ten atomic layers of graphene. By changing the crystal structure and sheet thickness, Carbon Nanosheet has distinct physical and chemical properties than those materials.

### BRIEF SUMMARY OF THE INVENTION

This invention is an electrochemical stripping analysis application/method/system/device, who uses electrodes comprising vertically free standing graphene containing Carbon Nanosheets.

Performance enhancement mechanism of vertically free standing graphene containing Carbon Nanosheets for electrodes for electrochemical stripping analysis is based on unique properties of the graphene material: high electrical conductivity, large specific surface, high structural strength, high chemical stability, large amount of edges and active sites.

As devices to conduct electrical current or electrical signal, electrodes naturally desire an low electrical resistance, especially on the surface or the interface where charges migrate between substances. Electrodes for electrochemical stripping analysis, which incorporates vertically free standing graphene containing Carbon Nanosheets on their surface, can enhance the sensitivity.

For electrochemical stripping analysis, electrodes' surfaces is the place where charge migrations between substances and chemical reactions happens, thus a large surface area is desired. This effect is especially favorable for electrodes where preconcentration of substance-to-be-analyzed occurs. The surface area of an electrode can be enhanced by 5-100 folds if coated by vertically free standing graphene containing Carbon Nanosheets, referring to FIG. 3.

For electrochemical stripping analysis, electrodes work in chemical solutions. Therefore, the electrodes are desired to be chemical stable. Even more, in some situation, the electrode works in a flowing fluid, thus the electrodes material needs to be physically strong. Vertically free standing graphene containing Carbon Nanosheets coatings on electrodes are both chemical stable and physically strong. Fully covered by vertically free standing graphene containing Carbon Nanosheets, a metal electrode becomes corrosion resistant.

Vertically free standing graphene containing Carbon Nanosheets can also work as a supporting structure for catalyst (e.g. platinum nano particles) and additives (e.g. mercury and bismuth) on an electrode for electrochemical stripping analysis. The very large active surface area of vertically free standing graphene containing Carbon Nanosheets can enhance load of mass and efficiency of the catalyst and additives.

It has been proved that some materials e.g. copper and lead, have a preferred nucleation effect on edges of carbon nano materials. Vertically free standing graphene containing Carbon Nanosheets have large number of edges which is favorable for attaching of these materials.

### BRIEF DESCRIPTION OF DRAWINGS

FIG. 1 is a perspective view of a simplified diagram of an electrochemical stripping analysis device in a cross-sectional view;

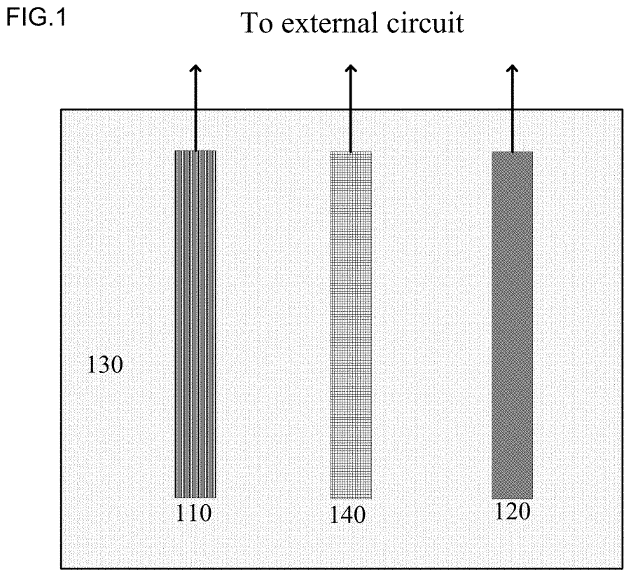

FIG. 2 is a schematic diagram of an exemplary vertically free standing graphene containing Carbon Nanosheet in a cross-sectional view;

FIG. 3 is a scanning electron microscopy (SEM) picture of vertically free standing graphene containing Carbon Nanosheets coating on a substrate, showing unique morphology and enlarged surface area, and the most distinct feature which is the thickness;

FIG. 4 is a schematic diagram of a variety of electrodes for electrochemical striping analysis with exemplary vertically free standing graphene containing Carbon Nanosheets directly grown on surface. 400 is an exemplary surface coated with vertically free standing graphene containing Carbon Nanosheets, 410 is an exemplary wire type electrode, 420 is an exemplary standard electrochemical electrode assembly with a metal or carbon material enclosed by inactive material, 430 is an exemplary mesh/net type electrode, 440 is an exemplary strip or bulk type electrode, 450 is an exemplary integrated or screen printed electrode, and 460 is an exemplary three dimensional electrodes-membrane assembly, where 461 and 463 are working and counter electrode respectively and 462 is a membrane.

FIG. 5 is a schematic diagram of exemplary substance-to-be-analyzed, catalyst particles, or additives attached on surface of vertically free standing graphene containing Carbon Nanosheets;

FIG. 6 is a scanning electron microscopy (SEM) picture of vertically free standing graphene containing Carbon Nanosheets before (a) and after (b) being evenly attached with nano-size mercury particles;

FIG. 7 is a scanning electron microscopy (SEM) picture of vertically free standing graphene containing Carbon Nanosheets with (a) and without (b) lead (Pb) grains nucleated on the edges;

FIG. 8 is a scanning electron microscopy (SEM) picture of vertically free standing graphene containing Carbon Nanosheets coating on a nickel mesh, forming an anti corrosion coating.

### DETAILED DESCRIPTION OF THE INVENTION

In accordance with techniques of certain exemplary embodiments, an electrode for electrochemical stripping analysis adopting vertically free standing graphene containing Carbon Nanosheets, is described herein. In the following description, for purpose of explanation, numerous specific details are set forth to provide a thorough understanding of the exemplary embodiments. It will be evident, however, to person skilled in the art that the exemplary embodiments may be practiced without these specific details.

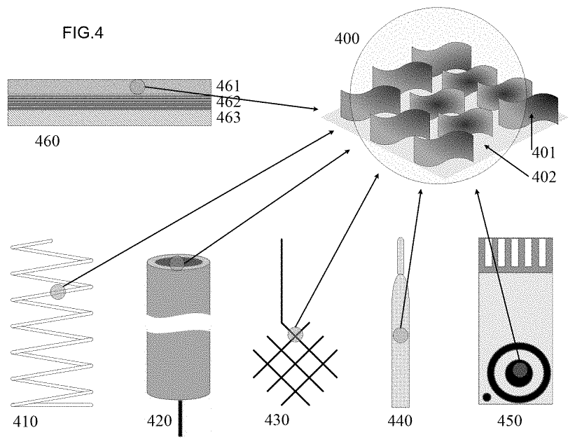

Referring now to the invention in more details, in FIG. 4, it shows a plurality of vertically free standing graphene and Carbon Nanosheets 400 coated on surface of a variety of electrodes for electrochemical stripping analysis 410, 420, 430, 440, 450, and 460. Electrodes for electrochemical stripping analysis are made of electrically conductive materials such as platinum, silver, gold, alloys, and carbon materials. The electrodes can be prepared into various morphologies, such as a wire 410, a needle, a rod assembly 420, a foil, a mesh 430, and a strip 440. The working electrode, counter electrode and reference electrode sometime are integrated into a chip like assembly to become micro electrode chips or screen printed electrodes 450. The electrodes can also be prepared as a thin film coated on a substrate. The surface of electrodes can be roughened, trenched, etched, foamed or “corrugated” in order to enlarge the active surface area. The electrodes, which usually have a planer shape, can be assembled with membrane to form an electrode-membrane assembly 460.

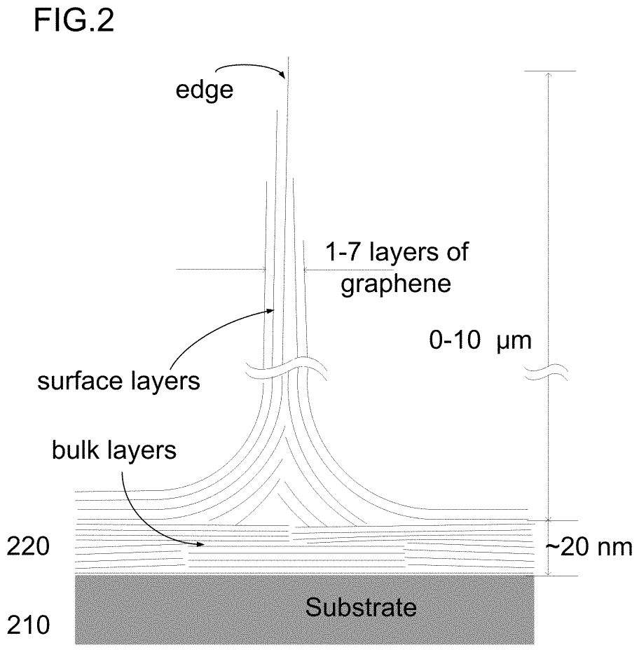

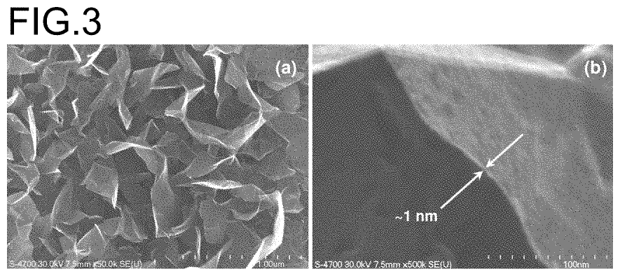

For the detailed structure of vertically free standing graphene containing Carbon Nanosheets 401, refer to FIG. 2 and FIG. 3.

A plurality of vertically free standing graphene containing Carbon Nanosheets 401 can be incorporated to or grow up in-situ on the electrode surface 402 through various methods known in prior art such as a thermal chemical vapor deposition method, a Microwave/RF plasma-enhanced chemical vapor deposition method or coating transfer. Surface of the vertically free standing graphene containing Carbon Nanosheets 401 can be activated by various methods. Likewise, the density (e.g. spatial density and width/height) of the vertically free standing graphene containing Carbon Nanosheets 401 and the attachment geometry between them and the electrode surface 402 may vary. By varying the spatial density of the vertically free standing graphene containing Carbon Nanosheets, active surface area of electrode can be modulated. The vertically free standing graphene containing Carbon Nanosheets 401 can also be of various sizes, thicknesses, and shapes (width and height). The vertically free standing graphene containing Carbon Nanosheets 401 can have a single layer or multiple layers of graphene.

The first exemplary embodiment is to coat vertically free standing graphene containing Carbon Nanosheets 401 on surface 402 of a variety of electrodes for electrochemical stripping analysis for the purpose of enhancing their electrical current conductivity in general.

In the first exemplary embodiment, the structure of vertically free-standing graphene containing Carbon Nanosheets 401 can dramatically enhance transport of electrons between electrodes. Especially, when a solid electrode dips in an electrolyte of chemical solution, large surface area of vertically free standing graphene containing Carbon Nanosheets 401 enhances the contact between electrode and electrolyte, thus the transport of electrons gets further enhanced. For an electrochemical stripping analysis electrode, the first exemplary embodiment decreases the inner resistance. A lower background resistance makes the devices more sensitive to the signal. Further more, a smaller resistance avoids scan curve distortion and enables faster scan rates.

The second exemplary embodiment is to coat vertically free standing graphene containing Carbon Nanosheets 401 on surface 402 of a variety of electrodes for electrochemical stripping analysis for the purpose of enhancing their surface area in general.

The surface of electrodes is the place where most of the chemical reactions as well as adsorption take place during electrochemical stripping analysis. In the second exemplary embodiment, an enlarged electrode surface directly expedite the reactions and adsorption. Enlarged electrode surface induces a stronger signal. For example, in anodic stripping voltammetry, cathodic stripping voltammetry and adsorptive stripping voltammetry, electrode surface coated with vertically free standing graphene containing Carbon Nanosheets provides a better limit of detection and linear range. Further more, an enlarged surface area of electrodes is very favorable to micro electrochemical devices. In many cases the miniaturization is limited because a minimum surface area of electrodes is required for a detectable signal. A 5 to 100 fold of enlarged surface area in the second exemplary embodiment means the minimum size of electrode can be reduced dramatically.

The third exemplary embodiment is to use vertically free standing graphene containing Carbon Nanosheets 530 coated on surface of electrodes 510 for electrochemical stripping analysis as supporter/carrier for substance-to-be-analyzed, additives, and catalysts, functional groups or bio-receptor 520.

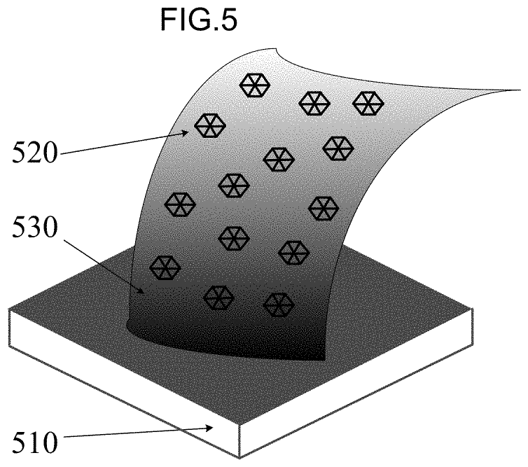

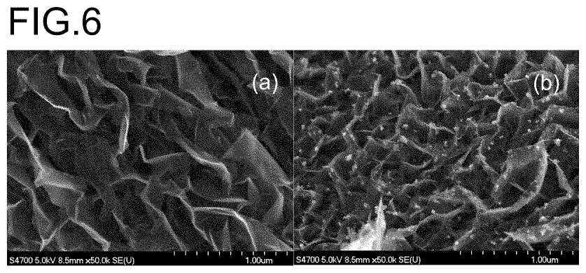

In the third exemplary embodiment, due to graphene materials' exceptional electrical conductivity, mechanical strength and larger surface area, vertically free standing graphene containing Carbon Nanosheets 530 is ideal carrier for nano-size catalyst particles of substance-to-be-analyzed, additives (e.g. mercury, bismuth, functional groups and bio-receptor), and catalysts (e.g. platinum), referring to FIG. 5. The catalyst particles 520 can be loaded by various methods like vapor deposition, sputtering deposition, electroplating, electrodeposition, printing, paste coating and chemical deposition. In the same way, vertically free standing graphene and Carbon Nanosheets 530 can support organic molecules, functional groups or bio-receptor. As a kind of carbon material, vertically free standing graphene and Carbon Nanosheets 530 can be covalently attached by functional groups, e.g. nitrogen-containing functional groups, oxygen-containing functional groups, amine, etc., for a variety of detect purpose. The covalent bonds can be formed through oxidation reaction, high temperature processing, radio-frequency plasma, etc. These functional groups attached to vertically free standing graphene containing Carbon Nanosheets can further work as receptor for other attachments. E.g. amine functional groups help to attach ruthenium on electrodes coated with vertically free standing graphene and Carbon Nanosheets. FIG. 6 is an example of nano-size mercury particles evenly attached on the surface of vertically free standing graphene containing Carbon Nanosheets.

The fourth exemplary embodiment is to utilize the edge effect of vertically free standing graphene containing Carbon Nanosheets 401 coated on surface of electrodes 402 for electrochemical stripping analysis as supporter/carrier for substance-to-be-analyzed, additives, and catalysts, functional groups or bio-receptor. It has been proved that some materials e.g. copper and lead, have a preferred nucleation effect on edges of carbon nano materials, e.g. graphene and carbon nano tubes.

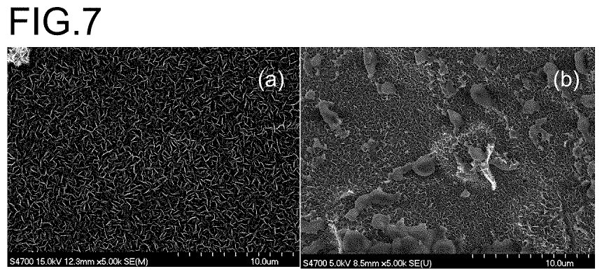

FIG. 7 shows an example of lead grains attached to a surface coated by vertically free standing graphene containing Carbon Nanosheets through the preferred nucleation effect on edges. The fourth exemplary embodiment realizes mercury free electrochemical stripping analysis of lead, copper, etc., which provides a more easy and clean way for trace metal pollution detection. Further more, vertically free standing graphene containing Carbon Nanosheets has a much larger density of graphene edges then carbon nano tubes and planer graphene for the same mass.

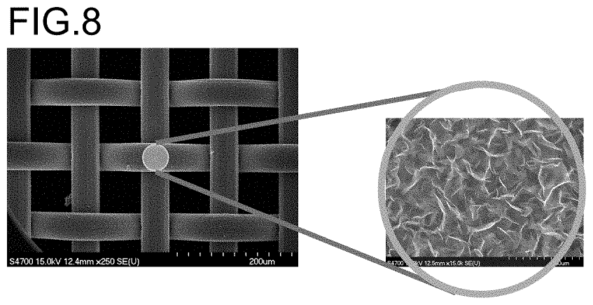

The fifth exemplary embodiment is to use vertically free standing graphene containing Carbon Nanosheets 401 as an anti corrosion coating on the surface 402 of electrodes for electrochemical stripping analysis. Due to graphene material's nature of chemical stable and physical strong, electrodes with such coating can be stable in various of chemical solutions, substituting the expensive noble metal electrodes. FIG. 8 is an example of nickel mesh coated by vertically free standing graphene containing Carbon Nanosheets working as counter electrode in electrochemical stripping analysis. The anti corrosion effect together with large surface area as well as good conductivity make it a perfect substitute for platinum counter electrode.

### PATENT CITATIONS

1. US7852612 B2, Xin Zhao, The College of William and Mary, “Supercapacitor using Carbon Nanosheets as electrode”.
2. US 8153240 B2, Jianjun Wang, et al. The College of William and Mary, “Carbon nanostructures and methods of making and using the same”.
3. US 20090011241 A1, Minyao Zhu et al., The College of William and Mary, “Carbon Nanoflake Compositions and Methods of Production”.
4. US20160226061 A1, Wei Zheng et al., “Batteries Using Vertically Free Standing Graphene, Carbon Nanosheets, and/or Three Dimensional Carbon Nanostructures as Electrodes”.
5. US20170190582 A1, Wenjie Fu et al., “Novel Methods To Grow Two Dimensional Nano-Materials By Using Solid-State Materials as Feedstock”.
6. US20170170486 A1, Wei Zheng et al., “Fuel Cells Using Vertically Free Standing Graphene and Carbon Nanosheets”.

### NON-PATENT CITATIONS

7. Wang et al., “Free-standing subnanometer graphite sheets,” Applied Physics Letters, Aug. 16, 2004, vol. 85, No. 7, pp. 1265-1267.
8. Wang et al., “Synthesis and field-emission testing of carbon nanoflake edge emitters,” J. Vac. Sci. Technol. B, May/Jun. 2004, vol. 22, No. 3, pp. 1269-1272.
9. Wang et al., “Synthesis of Carbon Nanosheets by inductively coupled radio-frequency plasma enhanced chemical vapor deposition,” Carbon, 2004, pp. 1-6.
10. Zhao, X. et al., “Thermal Desorption of Hydrogen from Carbon Nanosheets”, Journal of Chemical Physics, 124, 194704, 2006.
11. Noboru Oyama et al., “Introduction of amine functional groups on graphite electrode surfaces and their use in the attachment of ruthenium(II) to the electrode surface,” Journal of Electroanalytical Chemistry and Interfacial Electrochemistry Volume 87, Issue 3, 435-441, 1978.
12. John F. et al., “Introduction of functional groups onto carbon electrodes via treatment with radio-frequency plasmas,” Analytical Chemistry, 51 (3), 358-365, 1979.
13. Jacek Gebicki, “Application of electrochemical sensors and sensor matrixes for measurement of odorous chemical compounds,” Trends in Analytical Chemistry 77, 1-13, 2016.
14. Ulrich Guth et al., “Recent developments in electrochemical sensor application and technology—a review,” Meas. Sci. Technol. 20, 042002, 2009.
15. https://en.wikipedia.org/wiki/Electrochemical_stripping_analysis
16. Xuefei Guo et al., “Determination of Trace Metals by Anodic Stripping Voltammetry Using a Carbon Nanotube Tower Electrode,” Electroanalysis. 23, No. 5, 1252-1259, 2011.
17. N. G. Shang, K. Au, X. M. Meng et al., Chemical Physics Letters 358, 187, 2002.
18. K. Shiji, M. Hiramatsu, A. Enomoto et al., Diamond and Related Materials, 14 (3-7), 831, 2005.
19. Y. Wu, et al., Carbon Nanowalls Grown by Microwave Plasma Enhanced Chemical Vapor Deposition, Volume 14, Issue 1, pages 64-67, 2002.
20. Yihong Wu, et al., Carbon nanowalls and related materials, J. Mater. Chem., 14 , 469-477, 2004.
21. Mineo Hiramatsu, Masaru Hori, Carbon Nanowalls: Synthesis and Emerging Applications, Springer, 2010.

1. We claim an electrode for electrochemical stripping analysis that comprising at least one vertically free-standing graphene containing Carbon Nanosheets;

2. We claim a device, an equipment, an apparatus, or a system for electrochemical stripping analysis,
wherein the device, equipment, apparatus, or system comprises at least an electrode comprising at least one vertically free-standing graphene containing Carbon Nanosheets;

3. We claim a method for electrochemical stripping analysis,
wherein at least one vertically free-standing graphene containing Carbon Nanosheets are utilized in the method;

4. We claim a method of making electrode for electrochemical stripping analysis, comprising:
forming an electrode including a plurality of vertically free-standing graphene containing Carbon Nanosheets;
and providing the electrode into electrochemical stripping analysis;
and each of the plurality of Carbon Nanosheets comprises few layers of graphenes.
